(19) United States
(12) Patent Application Publication
(10) Pub. No.: US 2024/0190527 A1
(43) Pub. Date: Jun. 13, 2024

(54) FRONT HEADLIGHT AND TURN SIGNAL PLUG AND PLAY KIT FOR ELECTRIC SCOOTERS

(71) Applicant: Jimmy Dale Porter, III, Redwood City, CA (US)

(72) Inventor: Jimmy Dale Porter, III, Redwood City, CA (US)

(21) Appl. No.: 18/079,711

(22) Filed: Dec. 12, 2022

(51) Int. Cl. B62J 6/027; B62J 6/056; B62M 7/00

(52) U.S. Cl. CPC B62J 6/027; B62J 6/056; B62M 7/00; B62K 2202/00

(57) ABSTRACT

A light assembly for a scooter includes a first and a second bar mount component having a first and a second through hole respectively. The first or second through hole of the first or second bar mount component is slidably inserted on to a kiddy bar secured to a front portion of the scooter. The light assembly includes a center component having an elongated portion, each end of the elongated portion being attachable to an inner surface of the first or second bar mount components. The light assembly includes a headlight support piece attachable to the center component and the headlight support piece to support a weight of a front headlight of the scooter, and a metal rod extends through a third through hole of the center component and a fourth through hole at the front headlight to prevent the front headlight from detaching from the center component.

### FIELD

The disclosed embodiments relate generally to a plug and play kit and in particular, but not exclusively, to a front headlight and turn signal plug and play kit for electric scooters.

### BACKGROUND

A scooter is a mobility vehicle with a board for a rider to step on, two wheels, and a vertical handlebar for the rider to steer. Scooters and electric scooters (motorized scooters) are popular personal and leisure transportation partly due to being more economical, easier to operate, and does not require a driver's license.

### SUMMARY

Embodiments of a light assembly is disclosed to provide front headlights for an electric scooter.

According to a first aspect, a light assembly for a scooter includes a first bar mount component having a first through hole. The first through hole of the first bar mount component is slidably inserted on to one end of a kiddy bar that is secured to a front portion of the scooter. The light assembly includes a second bar mount component having a second through hole. The second through hole of the second bar mount component is slidably inserted on to another end of the kiddy bar secured to the front portion of the scooter. The light assembly includes a center component having an elongated portion, each end of the elongated portion being attachable to an inner surface of the first or second bar mount components. The light assembly includes a metal rod extending through a third through hole of the center component and a fourth through hole at a front headlight of the scooter to prevent the front headlight from detaching from the center component. The first bar mount component includes a first indent to receive a first signal light and the second bar mount component includes a second indent to receive a second signal light and the first and second signal lights are controllable to indicate an operator of the scooter intents to turn.

For one embodiment, the metal rod is secured to inner surfaces of the first and second bar mount components.

For one embodiment, the metal rod is flushed at outer surfaces of the first and second bar mount components to prevent the metal rod from detaching from the first or second bar mount components.

For one embodiment, the light assembly further includes a cover piece secured to a top portion of the first and second bar mount components, where the cover piece prevent light from the front headlight to be directed at the operator of the scooter.

For one embodiment, the light assembly further includes at least three electrical wires coupling an electronic controller of the scooter to the front headlight, the first signal light, and the second signal light to provide a signal to the front headlight, the first signal light, and the second signal light.

For one embodiment, the light assembly further includes a first clamp secured to the kiddy bar to lock in the first bar mount component to the kiddy bar and a second clamp secured to the kiddy bar to lock in the second bar mount component to the kiddy bar.

For one embodiment, the first bar mount component includes a first protruding knob and the first protruding knob is secured to a first clamp so the first clamp and the first bar mount component rotate along an axis of the kiddy bar in tandem, and the second bar mount component includes a second protruding knob and the second protruding knob is secured to a second clamp so the second clamp and the second bar mount component rotate along an axis of the kiddy bar in tandem.

For one embodiment, the first bar mount component includes a fifth through hole to fit an elongated bar and the elongated bar is secured to a first clamp so the first clamp and the first bar mount component rotate along an axis of the kiddy bar in tandem, and the second bar mount component includes a sixth through hole to fit the elongated bar and the elongated bar is secured to a second clamp so the second clamp and the second bar mount component rotate along an axis of the kiddy bar in tandem.

For one embodiment, the first and second bar mount components is rotatable on the kiddy bar to adjust a vertical direction of light projected by the first and second signal lights.

For one embodiment, the first bar mount component mirrors the second bar mount component along a vertical center axis to the light assembly.

For one embodiment, the light assembly further includes a headlight support piece attachable to the center component and the headlight support piece to support a weight of the front headlight.

According to a second aspect, a scooter includes a board for an operator to step on, two wheels attached to the board, a vertical handlebar attached to a front portion of the board, and an electronic controller secured to the board to control at least a motor to provide thrust to a wheel of the scooter, a kiddy bar secured to the vertical handlebar of the scooter, and a light assembly secured to the kiddy bar of the scooter. The light assembly includes a first bar mount component having a first through hole, where the first through hole of the first bar mount component is slidably inserted onto the kiddy bar. The light assembly for the scooter includes a second bar mount component having a second through hole, wherein the second through hole of the second bar mount component is slidably inserted on to the kiddy bar. The light assembly for the scooter includes a center component having an elongated portion, each end of the elongated portion being attachable to an inner surface of the first or second bar mount components. The light assembly for the scooter includes a metal rod extending through a third through hole of the center component and a fourth through hole at a front headlight of the scooter to prevent the front headlight from detaching from the center component. The first bar mount component includes a first indent to receive a first signal light and the second bar mount component includes a second indent to receive a second signal light and the first and second signal lights are controllable to indicate an operator of the scooter intents to turn.

### BRIEF DESCRIPTION OF THE DRAWINGS

The appended drawings illustrate examples and, therefore, are exemplary embodiments, and not to be considered limiting in scope.

FIG. 1 illustrates a perspective view of a scooter according to one embodiment;

FIG. 2A illustrates a perspective view of a light assembly of a scooter according to one embodiment;

FIG. 2B illustrates a front view of a light assembly according to one embodiment;

FIG. 2C illustrates a rear view of a light assembly according to one embodiment;

FIG. 3 illustrates a front view a center component respectively according to one embodiment;

FIG. 4 illustrates a side view of a center component respectively according to one embodiment;

FIGS. 5A-5D illustrate a side view, a front view, a top view, and a bottom view of a headlight support piece according to one embodiment;

FIGS. 6A-6D illustrate an inner side view, an outer side view, a rear view and a front view of a left bar mount component according to one embodiment;

FIGS. 7A-7D illustrate an inner side view, an outer side view, a rear view and a front view of a right bar mount component according to one embodiment;

FIGS. 8A-8D illustrate an inner side view, an outer side view, a rear view and a top view of a left bar mount component according to one embodiment; and

FIGS. 9A-9D illustrate an inner side view, an outer side view, a rear view and a top view of a right bar mount component according to one embodiment.

### DETAILED DESCRIPTION

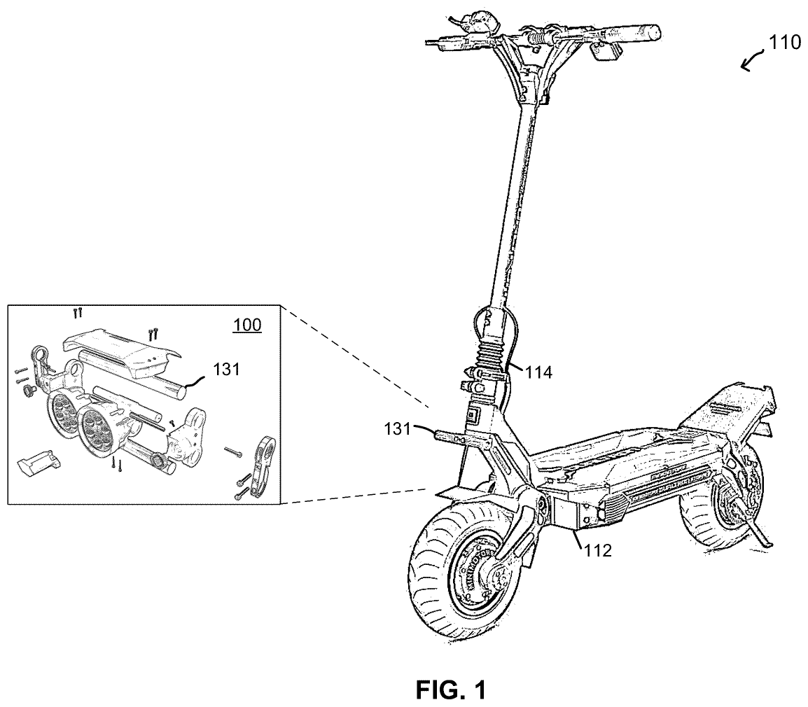

FIG. 1 illustrates a perspective view of a scooter 110 according to one embodiment. A scooter 110 can be a mobility vehicle with a board for a rider to step on, two wheels, and a vertical handlebar for the rider to steer. In one embodiment, scooter or electric scooter 110 includes a light assembly 100. Light assembly 100 can be secured to a bar (or kiddie bar) 131 that is attached to the vertical handlebar at the front of scooter 110. Scooter 110 can include a light emitting diode (LED) controller 112 and harness wirings 114 that can provide power and/or signals to one or more lights of light assembly 100.

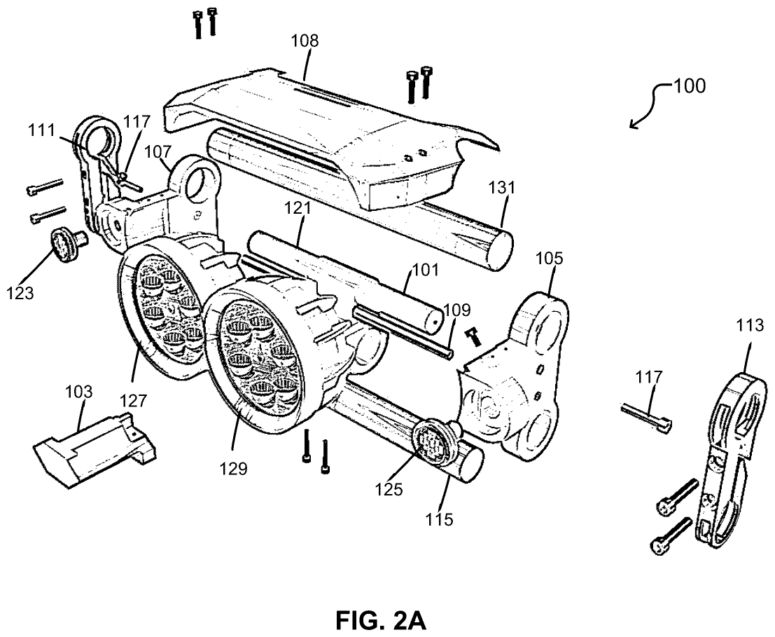

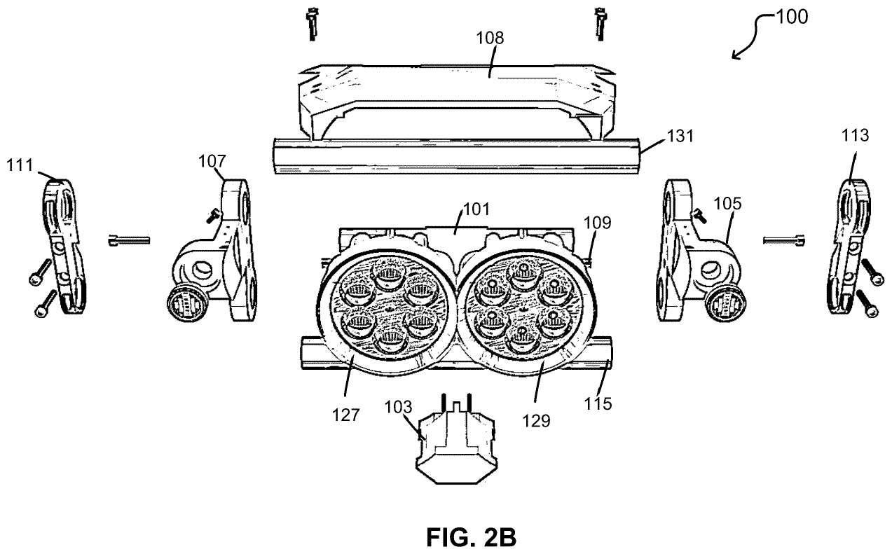

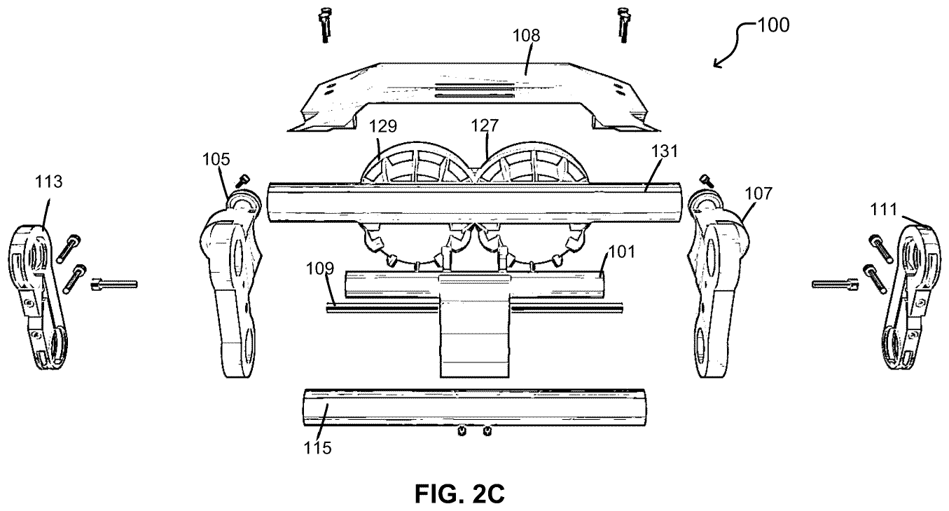

FIGS. 2A-2C illustrate a perspective view, a front view and a rear view of the light assembly 100 of a scooter 110 according to one embodiment. Referring to FIG. 2A, a light assembly 100 can include a center component 101, a headlight support piece 103, left and right bar mount components 105 and 107 and a metal rod 109. The center component 101 can be formed with an elongated portion 121 and each end of the elongated portion 121 is attachable to an inner surface of the two bar mount components 105 and 107. For some embodiments, left bar mount component 105 mirrors right bar mount component 107 along a vertical center axis of the light assembly.

Each of bar mount components 105 and 107 can have a through hole, where the through holes of the bar mount components are slidably inserted onto a kiddy bar 131 secured to a vertical handlebar of the scooter 110. Bar mount components 105 or 107 can include an indent to receive left and right signal lights 123 and 125. Left and right signal lights 123 and 125 are controllable to indicate the intent of an operator of the scooter 110 to turn. For some embodiments, the bar mount components 105 and 107 are rotatable on the kiddy bar 131 to adjust a vertical direction of light projected by signal lights 123 and 125.

Metal rod 109 can be disposed in a through hole of center component 101 and in a through hole at front headlights 127 and 129 of scooter 110 to prevent front headlights 127 and 129 from detaching from center component 101. For some embodiments, metal rod 109 can be secured to inner surfaces of bar mount components 105 and 107, respectively. For some embodiments, metal rod 109 may be flushed from the outer surfaces of bar mount components 105 and 107. Further the bar mount components 105 and 107 can prevent the metal rod 109 from detaching from bar mount components 105 and 107.

For some embodiments, light assembly 100 can further include a cover piece 108 secured to a top portion of the bar mount components 105 and 107. As such, the cover piece 108 prevents light from front headlights 127 and 129 to be directed at the operator of the scooter 110.

For some embodiments, the light assembly 100 can further include a harness with at least three electrical wires coupling an electronic controller 112 of the scooter 110 to front headlights 127-129 and signal lights 123-125 to provide a power and/or signal to the front headlights 127-129 and signal lights 123-125.

For one embodiment, light assembly 100 can further include clamps 111-113 which are secured to the kiddy bar 131 to lock in the bar mount component 105 or 107 to kiddy bar 131.

For some embodiments, the headlight support piece 103 can be attached to the center component 101 and the headlight support piece 103 is used to support the weight of the front headlights 127 and 129.

For some embodiments, any of bar mount components 105/107, headlight support piece 103, center component 101, and cover piece 108 can be three-dimensional (3D) printed using a 3D printer. The printing material can be PETG, ABS, PLA, or a combination of various blends. In some embodiments, the printing material is a biodegradable material.

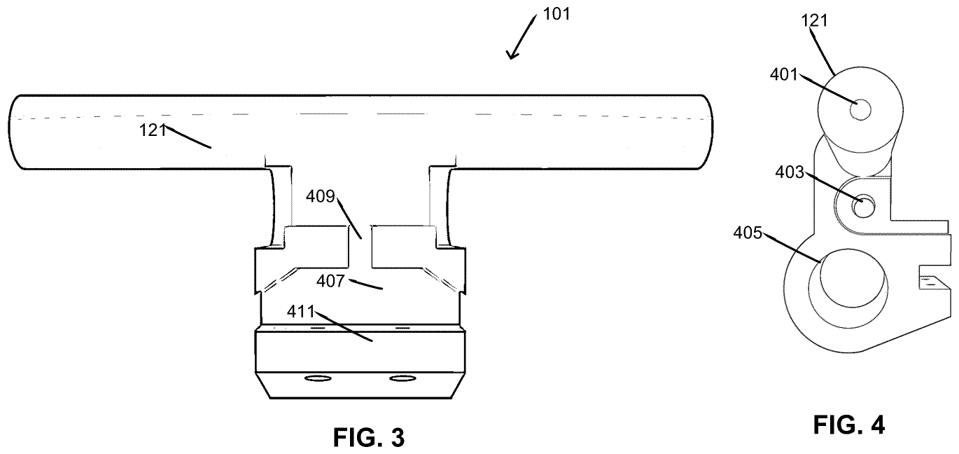

FIGS. 3-4 illustrate a front view and a side view of a center component 101 respectively according to one embodiment. As part of light assembly 100, center component 101 can include an elongated portion 121. For example, one end of elongated portion 121 can be attached to an inner surface of bar mount component 105 by screws 117 using screw holes 401, and another end of the elongated portion 121 can be attached to an inner surface of bar mount component 107 by screws 117 using screw holes 401. Although screw holes are shown, elongated portion 121 can be attached to bar mount components by other means, such as glue, key/socket, and/or some other male/female locking mechanisms.

For some embodiments, as shown in FIG. 4, a through hole 403 is disposed at center component 101 and situated below elongated portion 121. Metal rod 109 can be inserted in through hole 403 such that a length of metal rod 109 substantially parallels a length of elongated portion 121. Metal rod 109 can further be inserted through some through holes (not shown) of front headlights 127 and/or 129 of the scooters 110 to secure front headlights 127 and 129 to center component 101. To prevent front headlights 127/129 from drooping, two opposing ends of metal rod 109 are secured to inner sides of bar mount components 105 and 107.

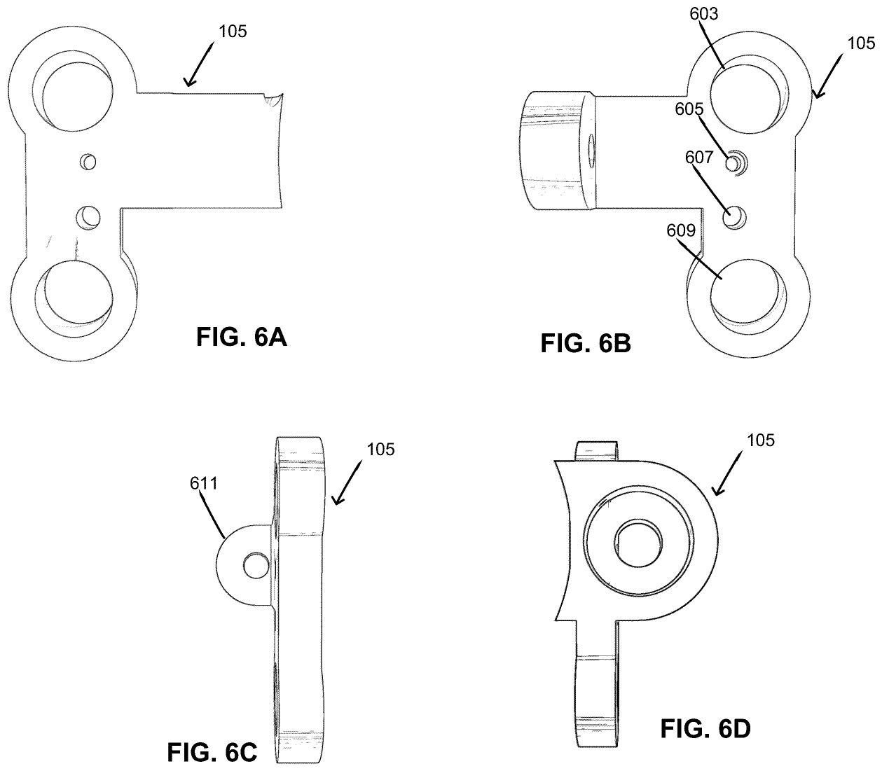

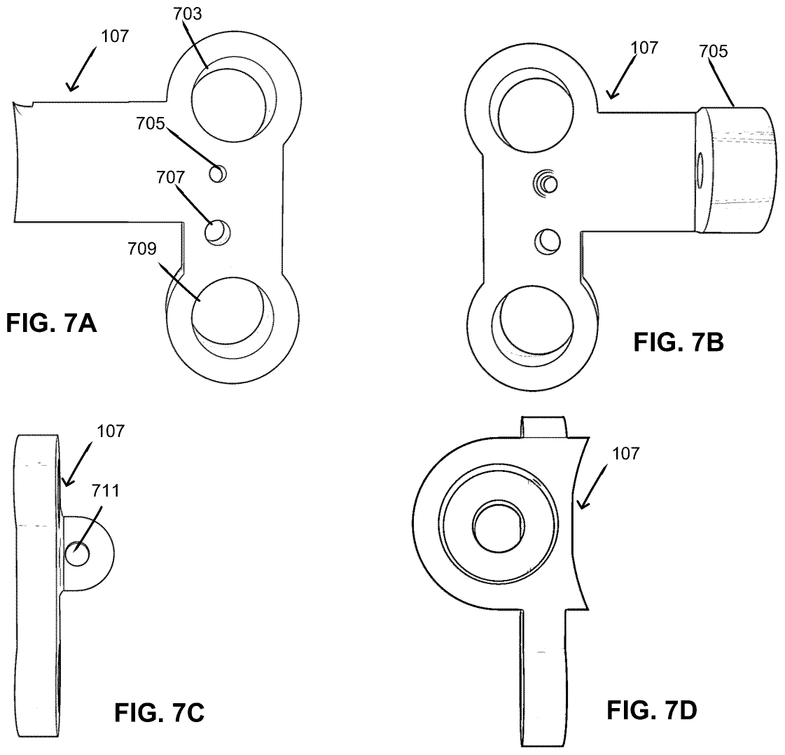

For one embodiment, through hole 405 is disposed at center component 101 just below through hole 403. Through hole 405 can fit a bar structure 115 (or another kiddie bar) such that a length of the bar structure 115 is substantially parallel to a length of elongated portion 121. Bar structure can be further secured to corresponding through holes at bar mount components 105 and 107, as further shown in FIGS. 6A and 7A.

For one embodiment, center component 101 includes guiding indents 407 and 409. Guiding indents 407 and 409 can guide a protrusion from a headlight support piece 103 to secure to center component 101. Center component 101 can further include screw holes 411 as attachable means for headlight support piece 103 to attach to center component 101.

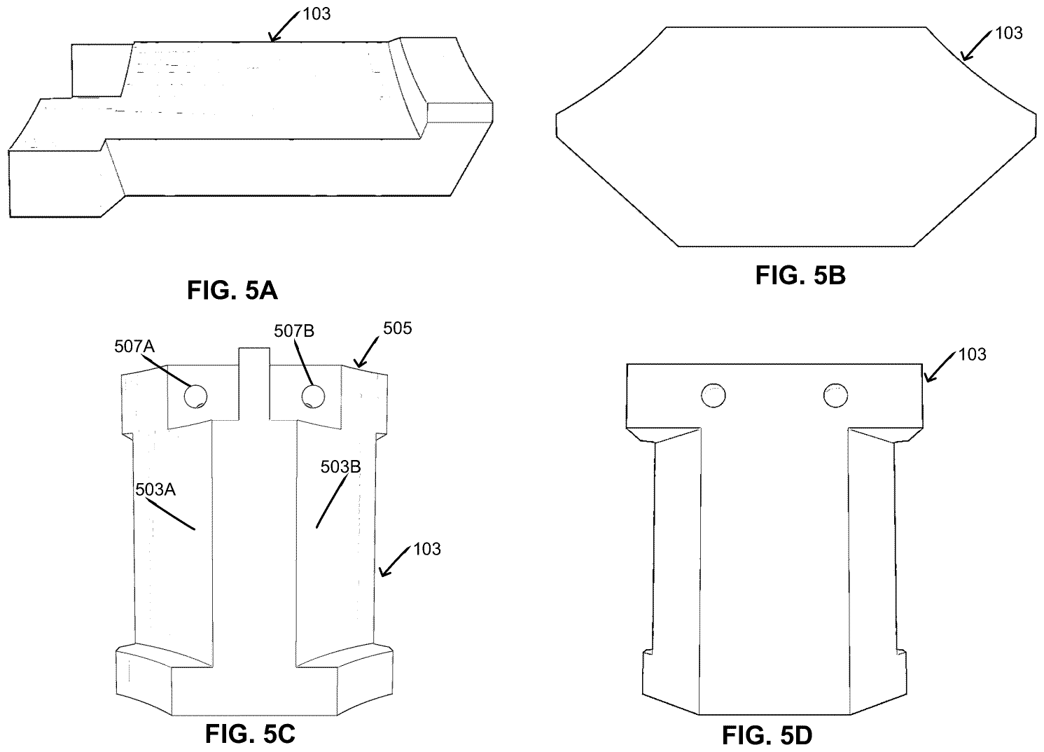

FIGS. 5A-5D illustrate a side view, a front view, a top view, and a bottom view of a headlight support piece 103 according to one embodiment. Headlight support piece 103 can be attached to center component 101. For one embodiment, headlight support piece 103 includes a protruding portion 505 as shown in FIG. 5C. Protruding portion 505 can be shaped to correspond to guiding indents 407 and 409 of center component 101, such that the headlight support piece 103 can be secured to center component 101. For example, protruding portion 505 includes a slit and a base, where the slit can fit in indent 409 and the base can fit in indent 407. Although shown as a slit and base, the shape of protruding portion 505 can be any other shapes. For example, the cross section of protruding portion 505 can be in the shape of a rectangular, triangle, rounded rectangle, and the like.

For one embodiment, as shown in FIG. 5C, headlight support piece 103 can include screw holes 507A and 507B as attachable means for headlight support piece 103 to attach to center component 101. For example, a screw can be inserted into screw hole 507A of headlight support piece 103 and one of the screw holes 411 of center component 101 so as to attach the headlight support piece 103 to center component 101.

For one embodiment, headlight support piece 103 can also be glued onto center component 101. Headlight support piece 103 can also be attached to center component 101 using other methods and the scope of the present application is not limited in this aspect.

The headlight support piece 103 can be used to support a weight of front headlights 127 and 129. For some embodiments, as shown in FIG. 5C, headlight support piece 103 can include inclined surface 503A and 503B to support the weights of front headlights 127 and 129. In one embodiment, headlight support piece 103 has a length greater than a length of front headlights 127 and 129 such that in the event of a fall, headlight support piece 103 can take a direct impact and minimizes damages to front headlights 127 and 129.

FIGS. 6A-6D illustrate an inner side view, an outer side view, a rear view and a front view of a left bar mount component 105 according to one embodiment. As shown in FIG. 6A, left bar mount component 105 can have a through hole 603 which can be slidably inserted on to kiddy bar 131 that is secured at the front portion of scooter 110.

For one embodiment, left bar mount component 105 can include a screw hole 605 situated just below through hole 603, where screw hole 605 is used for securing left bar mount component 105 to center component 101. For example, a distal end of elongated portion 121 of center component 101 can be attached to an inner surface of left bar mount component 105 by screws using screw hole 605.

For one embodiment, left bar mount component 105 can also include a through hole 607 situated below screw hole 605. Metal rod 109 can be inserted into through hole 607 to further secure left bar mount component 105 to center component 101. For example, one end of metal rod 109 can be inserted in through hole 607 while metal rod 109 is kept flushed at the outer surfaces of bar mount component 105. A clamp 113 secured at the outer surface of bar mount component 105 can prevent metal rod 109 from detaching from bar mount component 105.

For one embodiment, left bar mount component 105 can include a through hole 609 disposed under through hole 607. Through hole 609 can fit a bar structure 115 (or another kiddie bar) as mentioned in FIG. 4, such that the bar structure 115 can provide structural support for front headlights 127 and 129 and light assembly 100 in general.

For one embodiment, as shown in FIG. 6B, left bar mount component 105 can include a through hole 611 to receive signal light 125. For example, signal light 125 can flash to indicate an operator of the scooter 110 is about to turn left. The location of through hole 611 can be anywhere of left bar mount component 105 and the scope of the present application is not limited in this regard.

FIGS. 7A-7D illustrate an inner side view, an outer side view, a rear view and a front view of a right bar mount component 107 according to one embodiment. Similar to left bar mount component 107, as shown in FIG. 7A, right bar mount component 107 can include a through hole 703 which can be slidably inserted on to kiddy bar 131 secured at the front portion of scooter 110.

For one embodiment, as shown in FIG. 7A, right bar mount component 107 can further include holes 705, 707 and 709, which are similar to holes 605, 607 and 609 of left bar mount component 105. For example, screw hole 705 can be used to secure right bar mount component 107 to center component 101. Metal rod 109 can be inserted in through hole 707 at the inner side while the outer side of bar mount component 107 is flushed. Structure 115 can be inserted in through hole 709 to provide additional structure support for headlights 127-129.

For one embodiment, as shown in FIG. 7B, right bar mount component 107 can include a through hole 711 to receive a signal light 123. For example, signal light 123 can flash to indicate the scooter 110 is about to turn right. The location of through hole 711 can be anywhere on right bar mount component 107 and the scope of the present application is not limited in this regard.

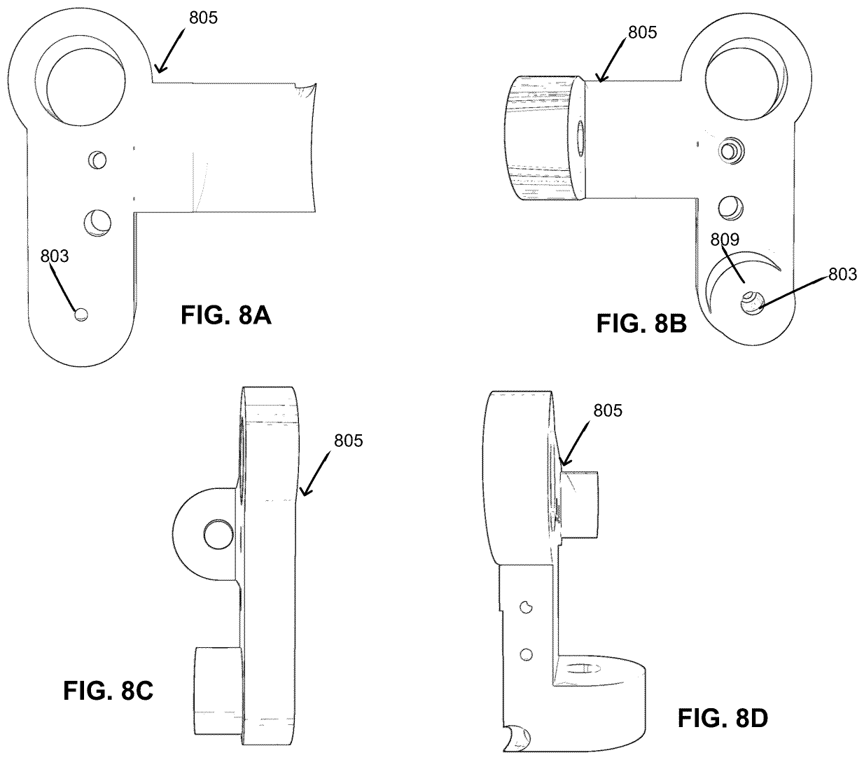

FIGS. 8A-8D illustrate an inner side view, an outer side view, a rear view and a top view of a left bar mount component 805 respectively according to one embodiment. Left bar mount component 805 can represent left bar mount component 105 of FIGS. 6A-6D, except that left bar mount component 805 includes protruding knob 809 instead of through hole 109. In one embodiment, protruding knob 809 includes a through hole 803 as shown in FIGS. 8A-8B. Protruding knob 809 can be secured to bar structure 115 by screws or the like using through hole 803. Protruding knob 809 can be secured to left clamp 113 so the clamp 113 and the left bar mount component 105 rotate along an axis of the kiddy bar 131 in tandem.

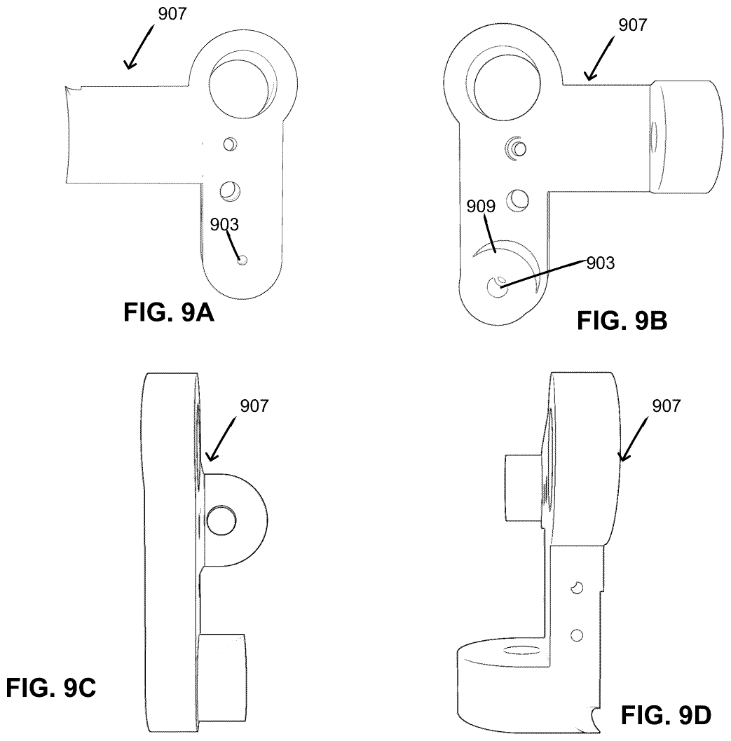

FIGS. 9A-9D illustrate an inner side view, an outer side view, a rear view and a top view of a right bar mount component 907 respectively according to one embodiment. Right bar mount component 907 can represent right bar mount component 107 of FIGS. 7A-7D, except that right bar mount component 907 includes protruding knob 909 instead of through hole 709. In one embodiment, protruding knob 909 includes a through hole 903 as shown in FIGS. 9A-9B. Protruding knob 909 can be secured to bar structure 115 by screws or the like using through hole 903. Protruding knob 909 can be secured to right clamp 111 so that clamp 111 and the right bar mount component 907 rotate along an axis of the kiddy bar 131 in tandem.

The previous description of the disclosed embodiments is provided to enable one to make or use the methods, device or article of the present disclosure. Various modifications to these embodiments will be readily apparent, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A light assembly for a scooter, comprising:
a first bar mount component having a first through hole, wherein the first through hole of the first bar mount component is slidably inserted on to a kiddy bar secured to a front portion of the scooter;
a second bar mount component having a second through hole, wherein the second through hole of the second bar mount component is slidably inserted on to the kiddy bar secured to the front portion of the scooter;
a center component having an elongated portion, each end of the elongated portion being attachable to an inner surface of the first or second bar mount components; and
a headlight support piece attachable to the center component and the headlight support piece to support a weight of a front headlight of the scooter; and
a metal rod extends through a third through hole of the center component and a fourth through hole at the front headlight to prevent the front headlight from detaching from the center component, wherein
the first bar mount component includes a first indent to receive a first signal light and the second bar mount component includes a second indent to receive a second signal light and the first and second signal lights are controllable to indicate an operator of the scooter intents to turn.

2. The light assembly of claim 1, wherein the metal rod is secured to inner surfaces of the first and second bar mount components.

3. The light assembly of claim 1, wherein the metal rod is flushed at outer surfaces of the first and second bar mount components to prevent the metal rod from detaching from the first or second bar mount components.

4. The light assembly of claim 1, further comprising a cover piece secured to a top portion of the first and second bar mount components, wherein the cover piece prevent light from the front headlight to be directed at the operator of the scooter.

5. The light assembly of claim 1, further comprising three electrical wires coupling an electronic controller of the scooter to the front headlight, the first signal light, and the second signal light to provide a signal to the front headlight, the first signal light, and the second signal light.

6. The light assembly of claim 1, further comprising a first clamp secured to the kiddy bar to lock in the first bar mount component to the kiddy bar and a second clamp secured to the kiddy bar to lock in the second bar mount component to the kiddy bar.

7. The light assembly of claim 1, wherein the first bar mount component includes a first protruding knob and the first protruding knob is secured to a first clamp so the first clamp and the first bar mount component rotate along an axis of the kiddy bar in tandem, and wherein the second bar mount component includes a second protruding knob and the second protruding knob is secured to a second clamp so the second clamp and the second bar mount component rotate along an axis of the kiddy bar in tandem.

8. The light assembly of claim 1, wherein the first bar mount component includes a fifth through hole to fit an elongated bar and the elongated bar is secured to a first clamp so the first clamp and the first bar mount component rotate along an axis of the kiddy bar in tandem, and wherein the second bar mount component includes a sixth through hole to fit the elongated bar and the elongated bar is secured to a second clamp so the second clamp and the second bar mount component rotate along an axis of the kiddy bar in tandem.

9. The light assembly of claim 1, wherein the first and second bar mount components is rotatable on the kiddy bar to adjust a vertical direction of light projected by the first and second signal lights.

10. The light assembly of claim 1, wherein the first bar mount component mirrors the second bar mount component along a vertical center axis to the light assembly.

11. A scooter, comprising:
a board for an operator to step on;
two wheels attached to the board;
a vertical handlebar attached to a front portion of the board;
a motor secured to the board;
an electronic controller secured to the board to control at least the motor to provide thrust to a wheel of the scooter;
a kiddy bar secured at the front portion of the scooter; and
a light assembly for the scooter, comprising:
a first bar mount component having a first through hole, wherein the first through hole of the first bar mount component is slidably inserted on to the kiddy bar secured at the front portion of the scooter;
a second bar mount component having a second through hole, wherein the second through hole of the second bar mount component is slidably inserted on to the kiddy bar secured to the front portion of the scooter;
a center component having an elongated portion, each end of the elongated portion being attachable to an inner surface of the first or second bar mount components; and
a headlight support piece attachable to the center component and the headlight support piece to support a weight of a front headlight of the scooter; and
a metal rod extends through a third through hole of the center component and a fourth through hole at the front headlight to prevent the front headlight from detaching from the center component, wherein
the first bar mount component includes a first indent to receive a first signal light and the second bar mount component includes a second indent to receive a second signal light and the first and second signal lights are controllable to indicate an operator of the scooter intents to turn.

12. The scooter of claim 11, wherein the metal rod is secured to inner surfaces of the first and second bar mount components.

13. The scooter of claim 11, wherein the metal rod is flushed at outer surfaces of the first and second bar mount components to prevent the metal rod from detaching from the first or second bar mount components.

14. The scooter of claim 11, further comprising a cover piece secured to a top portion of the first and second bar mount components, wherein the cover piece prevent light from the front headlight to be directed at the operator of the scooter.

15. The scooter of claim 11, further comprising three electrical wires coupling a controller of the scooter to the front headlight, the first signal light, and the second signal light to provide a signal to the front headlight, the first signal light, and the second signal light.

16. The scooter of claim 11, further comprising a first clamp secured to the kiddy bar to lock in the first bar mount component to the kiddy bar and a second clamp secured to the kiddy bar to lock in the second bar mount component to the kiddy bar.

17. The scooter of claim 11, wherein the first bar mount component includes a first protruding knob and the first protruding knob is secured to a first clamp so the first clamp and the first bar mount component rotate along an axis of the kiddy bar in tandem, and wherein the second bar mount component includes a second protruding knob and the second protruding knob is secured to a second clamp so the second clamp and the second bar mount component rotate along an axis of the kiddy bar in tandem.

18. The scooter of claim 11, wherein the first bar mount component includes a fifth through hole to fit an elongated bar and the elongated bar is secured to a first clamp so the first clamp and the first bar mount component rotate along an axis of the kiddy bar in tandem, and wherein the second bar mount component includes a sixth through hole to fit the elongated bar and the elongated bar is secured to a second clamp so the second clamp and the second bar mount component rotate along an axis of the kiddy bar in tandem.

19. The scooter of claim 11, wherein the first and second bar mount components is rotatable on the kiddy bar to adjust a vertical direction of light projected by the first and second signal lights.

20. The scooter of claim 11, wherein the first bar mount component mirrors the second bar mount component along a vertical center axis to the light assembly.
